(19) United States
(12) Patent Application Publication
(10) Pub. No.: US 2014/0314337 A1
(43) Pub. Date: Oct. 23, 2014

(54) IMAGE DISPLAY METHOD

(71) Applicant: KABUSHIKI KAISHA TOSHIBA, Tokyo (JP)

(72) Inventors: Tatsuya Miyake, Inagi-shi (JP); Tatsuhiro Nishioka, Kawasaki-shi (JP); Shinzo Matsubara, Akishima-shi (JP); Tan Wang, Kawasaki-shi (JP); Toshihiro Morohoshi, Kawasaki-shi (JP)

(73) Assignee: KABUSHIKI KAISHA TOSHIBA, Tokyo (JP)

(21) Appl. No.: 14/185,657

(22) Filed: Feb. 20, 2014

(30) Foreign Application Priority Data
Apr. 22, 2013 (JP) 2013-089682

(51) Int. Cl. G06T 11/60

(52) U.S. Cl. CPC G06T 11/60
USPC 382/309

(57) ABSTRACT

In an image display method, when image editing is performed for image data of a captured still image by an image editing program, file data of the edited image data is transmitted from a personal computer for performing the image editing to a television. After the file data of the edited image is received by a television, the file data of the edited image data is decoded by a decoder, and a still image generated by decoding is displayed on a screen of the television.

### CROSS-REFERENCE TO RELATED APPLICATION(S)

This application is based upon and claims the benefit of priority from Japanese Patent Application No. 2013-089682, filed on Apr. 22, 2013; the entire contents of which are incorporated herein by reference.

### FIELD

Embodiments described herein relate generally to an image display method.

### BACKGROUND

A digital camera has been widely used in recent years. An image captured by a digital camera is recorded on a portable recording medium as digital data, and can be stored in an internal or external storage of a personal computer (hereinafter, referred to as a PC).

A photo or a still image captured by a digital camera is not only printed, but also often displayed on an image display unit such as a TV receiver (hereinafter, referred to as a TV) for viewing. As the number of pixels of a digital camera has been increased, a high-resolution image can be captured. A digital camera user can view a captured image on a large screen high-definition TV.

On the other hand, it has become popular to edit an image captured by a digital camera by an image editing software program (hereinafter, referred simply to as a program).

An image captured by a digital camera can usually be edited on a PC by various image processing of an image editing program. As an image editing program, “Photoshop” of Adobe Corporation is well known. An image to be edited by an image editing program is displayed on a PC monitor, and an editor performing image editing performs editing while viewing an image displayed on the monitor.

However, for editing an image captured by a digital camera on a PC, and viewing the edited image on a TV, it is necessary to record edited image data on a portable medium such as a memory card, and to reproduce the image by connecting the memory card to a connector of TV. Thus, a user is required to do tedious connection and disconnection of a portable medium. In particular, each time an image is edited on a PC, a user has to repeat the tedious connection and disconnection of a portable medium for checking an effect of editing on a large TV screen.

Further, technology of adjusting brightness of a video signal output from a digital camera and a screen size has been proposed so that deterioration of an image quality can be prevented when displaying the captured image of the digital camera on a TV screen from a video terminal of a digital camera by using a cable, such as an HDMI (registered trademark), to connect in-between.

However, when an image signal of an image captured by a digital camera is transmitted and displayed to a TV via a cable and when connecting a digital camera or a PC and a TV screen, the image signal that is output to the TV is decoded and generated on a side of the digital camera or the PC. In other words, an image is affected by image setting or image adjustment on a transmitting side such as a PC, which ends up being deterioration of image quality displayed on a TV screen. For example, it is possible to connect a TV to a PC and to display a PC image on a TV. But, a TV is affected by image setting in a PC, and an image signal varies according to a type of a cable such as an HDMI (registered trademark) cable.

Therefore, when editing an image captured by a digital camera on a PC as an editing unit while displaying on a TV as a separate display unit, there arises a problem such that tedious steps are required but image quality is decreased.

### BRIEF DESCRIPTION OF THE DRAWINGS

FIG. 1 is a configuration diagram of an image display system according to a first embodiment.

FIG. 2 is a block diagram showing a configuration of a PC 2 according to a first embodiment.

FIG. 3 is a block diagram showing a configuration of a TV 3 according to a first embodiment.

FIG. 4 is a flowchart showing an exemplary processing flow of a photo regeneration processing program 21a in a photo play mode of a TV 3 according to a first embodiment.

FIG. 5 is a flowchart showing an exemplary processing flow when an image editing program 12a is executed in a PC 2 according to a first embodiment.

FIG. 6 is a configuration diagram of an image display system 1A according to a second embodiment.

FIG. 7 is a block diagram showing a configuration of a PC 2A according to a second embodiment.

FIG. 8 is a block diagram showing a configuration of a TV 3A according to a second embodiment.

FIG. 9 is a flowchart showing an exemplary processing flow of a photo play mode program 21b according to a second embodiment.

FIG. 10 is a flowchart showing an exemplary processing flow of an editing process in a PC 2 according to a second embodiment.

### DETAILED DESCRIPTION

According to one embodiment, an image display method including: editing image data of a captured still image by an image editing unit according to an image editing program; transmitting file data of the edited image data from the image editing unit to a display unit; receiving the file data of the edited image data by the display unit; decoding the received file data of the edited image data by a decoder; and displaying a still image of image data which is generated by decoding the received file data on a screen of the display unit.

Various embodiments will be described hereinafter with reference to the accompanying drawings.

### First Embodiment

(Configuration)

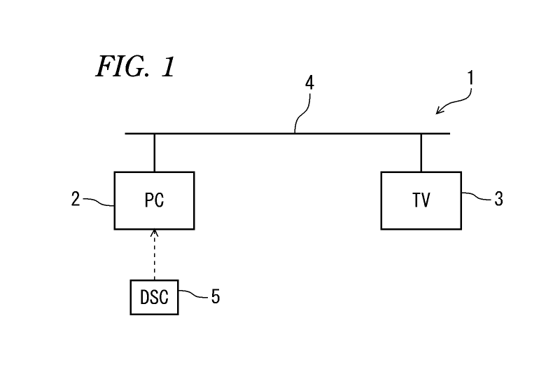

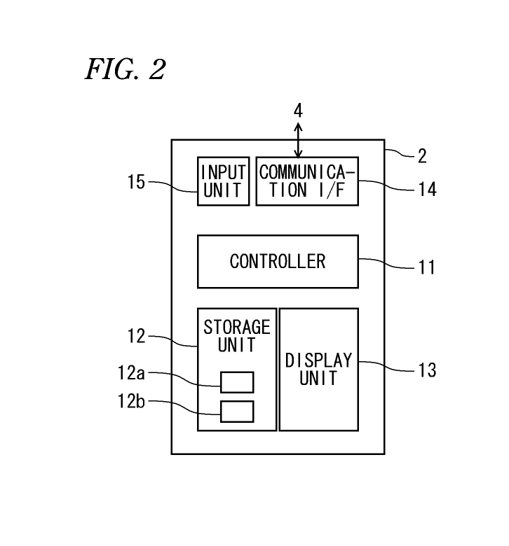

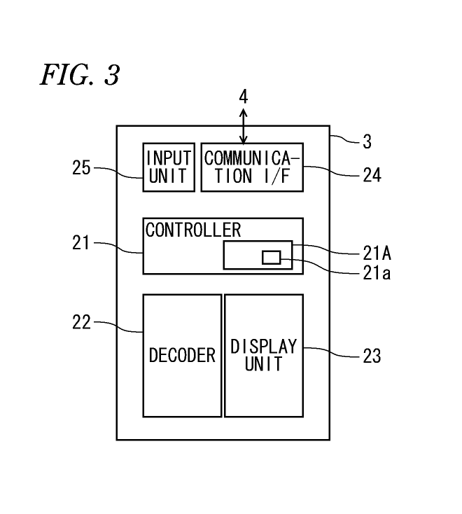

FIG. 1 is a configuration diagram of an image display system according to the first embodiment. FIG. 2 is a block diagram showing a configuration of a PC 2. FIG. 3 is a block diagram showing a configuration of a TV 3.

The image display system 1 includes a PC 2, a TV 3, and a network 4. The PC 2 and TV 3 are communicably connected via the network 4. The network 4 is a wired or wireless network.

The PC 2 as an image editing unit for performing image editing includes a controller 11, a storage unit 12, a display unit 13, a communication interface (hereinafter, referred to as a communication I/F), and an input unit 15.

The controller 11 includes a central processing unit (hereinafter, referred to as a CPU), and is configured to execute various programs stored in the storage unit 12.

The storage unit 12 includes a ROM, a RAM, and a hard disk drive. The ROM stores various programs for controlling the entire PC 2 and realizing various functions. The hard disk unit stores various application programs including an image editing program described later. The PC 2 is configured so that the CPU of the controller 11 reads the various programs from the storage unit 12, deploys them to the RAM, and executes them.

The storage unit 12 stores an image editing software program (hereinafter, referred to as an image editing program) 12a, and a plug-in software program (hereinafter, referred to as a plug-in program) 12b described later. The plug-in program 12b is a plug-in program for adding a function to the image editing program 12a, and is executed together with the image editing program 12a.

The display unit 13 is a display panel such as a liquid crystal display unit (LCD). As the display unit 13 of the PC 2 displays a still image to be edited, the PC 2 can be called an editing display unit.

The communication I/F 14 is an interface circuit for the network 4.

Therefore, the PC 2 can communicate with the TV 3 via the communication I/F 14 and network 4.

The input unit 15 is a mouse, a keyboard, or the like of the PC 2. A user to perform image editing can input various image editing commands and values to the PC 2 by using the input unit 15.

The TV 3 includes a controller 21, a decoder 22, a display unit 23, a communication I/F 24, and input unit 25. The TV 3 is a high-definition TV, for example, a so-called 4K TV or 8K TV, and is configured not only to be able to watch a broadcast program, but also to be able to display a would-be edited still image in high definition as will be described later. However, the TV 3 can be recognized as a viewing display unit, if the TV 3 itself is used as a display unit merely for displaying a still image for viewing. Further, although not illustrated here, the TV 3 includes a tuner or the like for watch a broadcast program.

Further, the TV 3 has several operation modes, and the modes include a photo play mode described later as a predetermined playback mode (which includes a first play mode).

The controller 21 includes a storage unit 21A including a CPU, a ROM, and a RAM. The ROM stores various programs for controlling the entire TV 3 and realizing various functions. The controller 21 is configured to execute various programs stored in the ROM. The ROM stores also a photo regeneration processing program 21a as will be described later.

The decoder 22 is a processor to decode image data of a predetermined formatted still image. In the embodiment, file data of an image is compressed in a JPEG format, and the decoder 22 decodes the JPEG file data.

The display unit 23 is a display panel such as a liquid crystal display (LCD) capable of displaying a high-resolution image.

The communication IF 24 is an interface circuit for the network 4.

The input unit 25 is a receiving unit to receive signals from an operation panel and a remote controller.

The PC 2 can store image data captured by a digital camera (DSC) 5 in a hard disk drive of the storage unit 12. For example, by inserting a memory card, which was inserted in the digital camera 5, into a memory card slot of the PC 2 and copying data to the hard disk drive, a user can copy an image captured by the digital camera 5 to the PC 2.

The image copied to the PC 2 can be edited by the image editing program 12a. The image editing program 12a is a program for editing an image by applying various image processing such as various corrections and enhancements to an image.

In the image display system in FIG. 1, an image being edited on the PC 2 is displayed on the TV 3, and a user to perform image editing views an image displayed on the TV 3, checks an edited image state, and can perform further image editing.

In such a case, the TV 3 can display an image with so-called high resolution, and a user can view a high-resolution image displayed on the TV 3, and edit the image by finely checking the editing state.

(Functions)

Next, functions of the image display system 1 will be explained.

A user sets the TV 3 to a predetermined operation mode, for example, a photo play mode so as to receive file data of an image transmitted from the PC 2 and display the image on a screen of the TV 3. A user can set the TV 3 to a photo play mode by operating a remote controller or the like. An instruction for setting a photo play mode is entered the input unit 25. Based on the instruction entered the input unit 25, the controller 21 can determine that the TV 3 has been set to a photo play mode. The control 21 executes the regeneration processing program 21a according to the set photo play mode.

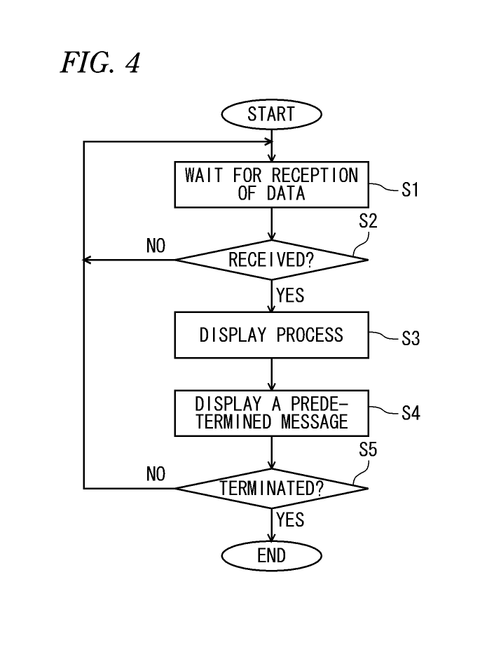

FIG. 4 is a flowchart showing an exemplary processing flow of the photo regeneration processing program 21a in a photo play mode of the TV 3. First, when the TV 3 is set to a photo play mode, the controller 21 waits for reception of image data via the network 4 (S1).

The controller 21 determines whether the image data has been received (S2). When the image data has not received (S2: NO), the processing returns to step S1.

When the image data has been received (S2: YES), the controller 21 executes display processing for displaying the received data (S3). The controller 21 decodes file data as received data by the decoder 22, and displays it on the display unit 23.

After step S3, the controller 21 generates a message indicating update of display, such as “Display is updated”, and displays it on a screen of the TV 3 (S4). By such a message, a user becomes aware of the received image data being displayed on the TV 3. Further, as will be described later, a user can also recognize that the image data after editing is displayed on the TV 3.

After step S4, the controller 21 determines whether termination of the photo play mode is instructed (S5). When termination of the photo play mode is not instructed (S5: NO), the processing returns to step S1. When termination of the photo play mode is instructed (S5: YES), the processing is terminated.

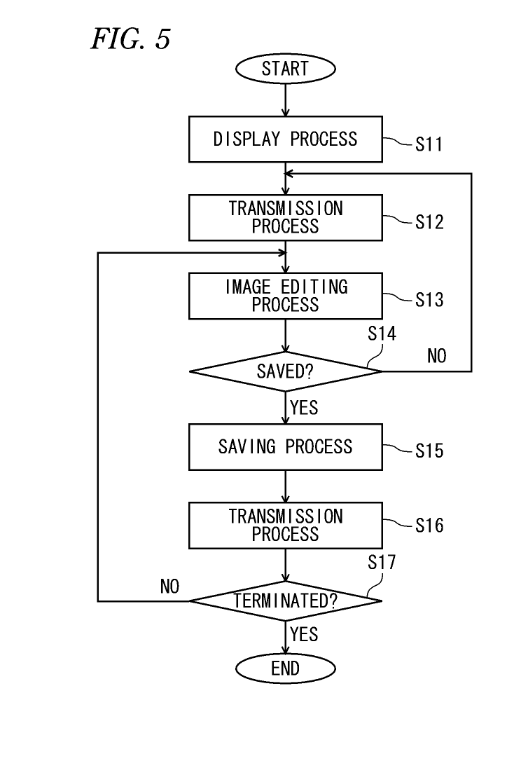

FIG. 5 is a flowchart showing an exemplary processing flow when the image editing program 12a is executed in the PC 2. The processing of FIG. 5 is performed by the image editing program 12a and plug-in program 12b.

When the image editing program 12a is executed, a user specifies an image file to be edited out of multiple image files stored in the hard disk drive, and the controller 11 executes display processing for decoding and displaying file data of the image specified as an editing object (S11) by the function of the image editing program 12a.

Next, the controller 11 executes transmission processing for transmitting file data of an image to the TV 3 by the function of the plug-in program 12b (S12). In step S12, the controller 11 may transmit file data before decoding in step S11, or may transmit file data of the image that is encoded from file data of the displayed image by the plug-in program 12b. In other words, the plug-in program 12b has an image encoding function.

The image editing program 12a deploys image data to be edited stored in the storage unit 15 on the RAM, and executes editing for the data on the RAM.

The controller 11 executes an image editing process for editing various images by the function of the image editing program 12a (S13). In the image editing process in step S13, various functions of the image editing program 12a allows the user to edit an editing object image based on his desired editing instructions which can be input to the input unit 15.

After the processing in step S13, the controller 11 determines whether a saving instruction is entered by a user (S 14) by the function of the image editing program 12a. When the saving instruction is not entered (S 14: NO), the processing returns to step S12, and the controller 11 transmits file data that is generated by encoding edited image data by the plug-in program 12b (S12). Saving is instructed by a user by entering a data saving command into the input unit 15.

In step S13, for example, when an instruction to execute a command such as a noise removal command is entered or a command is executed, the controller 11 can determine whether the command execution instruction is entered, based on an input instruction to the input unit 15. When such a command execution instruction is entered, the controller 11 makes determination in step S14, assuming that the process in step S13 has been executed. In other words, the plug-in program 12b determines that the process in step S13 has been executed, by monitoring an execution state of the image editing program for performing image editing.

When the image editing process in S13 is executed, the image data on the RAM is updated. Then, the plug-in program 12b monitors execution of writing to the RAM by monitoring an execution state of the image editing program 12a. In other words, the plug-in program 12b detects whether the image editing has been performed, by monitoring the execution state of the image editing program for performing image editing.

When saving is instructed (S14: YES), the controller 11 executes saving an edited image by the function of the image editing program 12a (S 15). In step S15, image data is saved by encoding to a specified file data format, here, a JPEG format.

When the saving process is terminated, the controller 11 executes transmission of the image data saved in step S15 by the function of the plug-in program 12b (S 16).

After step S16, the controller 11 determines whether an instruction to terminate execution of the image editing program 12a is entered (S17). When the termination instruction is entered (S17: YES), the processing is terminated.

When the termination instruction is not entered (S 17: NO), the processing is moved to step S13.

As a result, the image data transmitted by the plug-in program 12b in steps S12 and S16 is received by the TV 3, and decoded by the decoder 22 by the processing in steps S1 to S3 in FIG. 4, and the still image decoded by the decoder 22, and image edited is displayed on the display unit 23.

As described above, when the image editing program edits image data of a captured still image, the PC 2 as an image editing unit for performing image editing sends file data of the edited image to the display unit. Receiving the file data of the edited image, the TV 3 as a display unit decodes file data of the edited image by a decoder, and displays a still image generated by decoding on the screen of the TV 3. The PC 2 sends file data of the edited image by the plug-in program 12b for adding a function to the image editing program 12a.

The TV 3, having a photo play mode as a predetermined playback mode, receives file data of the edited image, decodes file data of the edited image, and display a still image generated by decoding, in a photo play mode.

Therefore, according to the image display system of the embodiment described above, when an image is edited by the PC 2 as an editing unit, a user can display an image being edited on the TV 3 as a separate display substantially in real time, and can easily edit the image being displayed on the TV 3 without deteriorating image quality, while monitoring the high-quality image.

In the above example, the PC 2 encodes image data deployed on a RAM to a predetermined format (here, a JPEG format), and then sends the image data. However, the PC 2 may be configured to send the image data deployed on a RAM as it is. In this case, the TV3 is provided with a decoder for decoding the data on the RAM, and the TV 3 decodes received data by the decoder, and displays the data on the display unit 23.

### Second Embodiment

In the first embodiment, a PC and TV are connected via a network, and image data of a still image an editing object is saved in the PC. In the second embodiment, a PC and TV are connected via a network, but the image data is saved in a file server.

(Configuration)

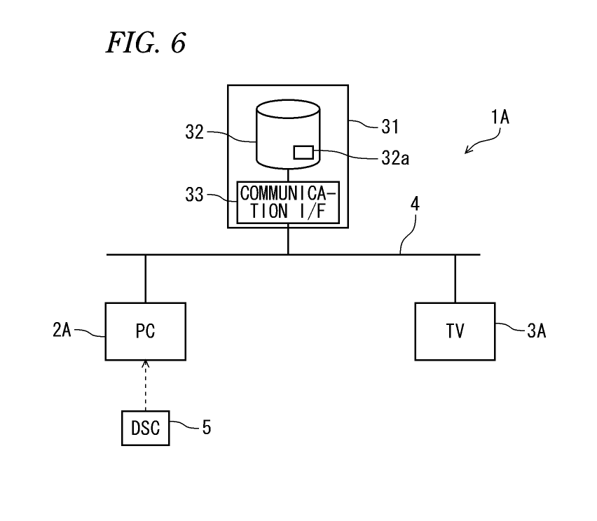

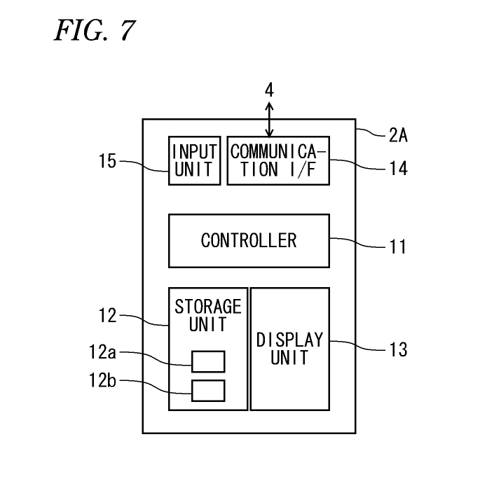

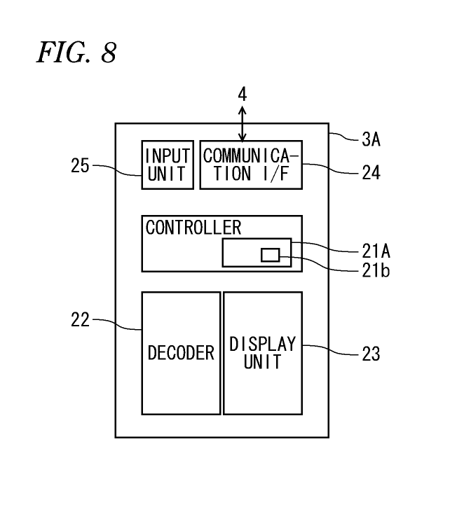

FIG. 6 is a configuration diagram of an image display system 1A according to the embodiment. FIG. 7 is a block diagram showing a configuration of a PC 2A. FIG. 8 is a block diagram showing a configuration of a TV 3A. In the image display system of the embodiment, the same components as those in the first embodiment are given to the same reference numerals, the description thereof is omitted, and only different components are explained. The PC 2A and TV 3A have substantially the same configurations as those of the PC 2 and TV 3 in the first embodiment. The TV 3A is a high-definition TV, for example, a so-called 4K TV or 8K TV, and is configured to be able to listen to a broadcast program and to display a still image to be edited as will be described later.

The image display system 1A comprises a PC 2A, a TV 3A, and a network attached storage (hereinafter, referred to as a NAS) as a file server. The PC 2A, TV 3A, and NAS 31 are communicably connected via the network 4.

The NAS 31 includes a not-shown controller, a hard disk drive 32, and a communication I/F 33. The NAS 31 causes the PC 2A and TV 3A to share image data recorded in the hard disk drive 32, which is recognized as a common storage unit. The NAS 31 is a file server that is controlled by a not-shown controller, and is capable of reading and writing a file from/to the hard disk drive 32 via the communication I/F 33.

In the image display system 1A of the configuration shown in FIG. 6, an image being edited on the PC 2A is displayed on the TV 3A, and a user to perform image editing views the image under editing displayed on the TV 3A, checks the editing state, and can perform further image editing.

At this time, as the TV 3A can display an image with high resolution, a user as an editor can edit an image while monitoring a high-definition image being displayed on the display unit 23 of the TV 3A.

The storage unit 12 of the PC 2A stores an image editing transmission processing program 12c described later.

The controller 21 of the TV 3A stores a photo play mode program 21b described later.

In the hard disk drive 32 of the NAS 31, a storage area 32a to store data of a predetermined folder (which includes a first folder) is generated as described later.

(Functions)

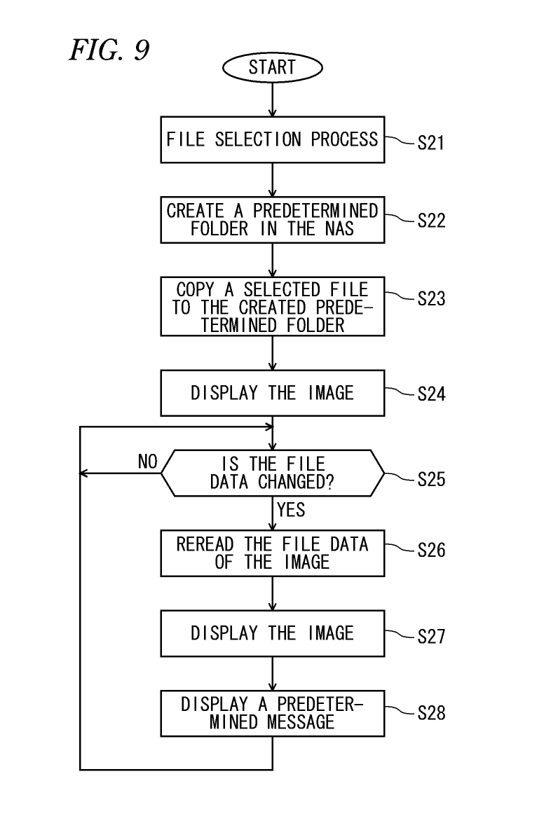

FIG. 9 is a flowchart showing an exemplary processing flow of a photo play mode program 21b.

When a user to perform image editing sets the TV 3A to a photo play mode as a predetermined mode, the photo play mode program 21b is executed by the controller 21 of the TV 3A. In particular, when a photo play mode is set, a CPU of the controller 21 reads and executes the photo play mode program 21b stored in a storage unit 21A included in the controller 21.

When the photo play mode 21b of FIG. 9 is executed, first, the controller 21 executes a file selection process (S21). In step S21, a predetermined menu screen is displayed on a TV screen, and a user can select an image to reproduce according to instructions on the menu screen.

Thus, in the file selection process, the controller 21 displays a predetermined menu on the screen of the display unit 23 of the TV 3A, and by following a selection instructions shown on the menu screen, a user can display a list of the images on the display unit 23 by retrieving the list stored in the NAS 31. And, a user selects a file of an image to be edited out of the displayed list of images, thereby a file to be reproduced on the TV 3A is selected.

Next, when the file selection process is executed, and a file is selected, the controller 21 generates a predetermined folder in a predetermined storage area (which includes a first storage area) 32a of the NAS 31 (S22). The controller 21 generates a predetermined file in a predetermined hierarchy (for example, a hierarchy beneath a root), and gives a predetermined folder name to the generated predetermined folder. In other words, when an operation mode is changed to a photo play mode as a predetermined operation mode, the TV 3A as a display unit generates a predetermined folder in a predetermined storage area of the NAS 31 as a storage unit.

The controller 21 copies the image file selected in step S21 to the predetermined folder generated in step S22 (S23), retrieve the selected and copied image file, and executes an image display process for displaying an image on a screen of the display unit 23 (S24).

As the image data stored in the NAS 31 is file data, in the TV 3A, the retrieved file data is decoded by the decoder 22, and the image is displayed.

Next, image editing is performed in the PC 2A. As a user has selected an editing object image in the TV 3A, the PC 2A can retrieve the selected image from the NAS 31, which allows the user to perform various editing.

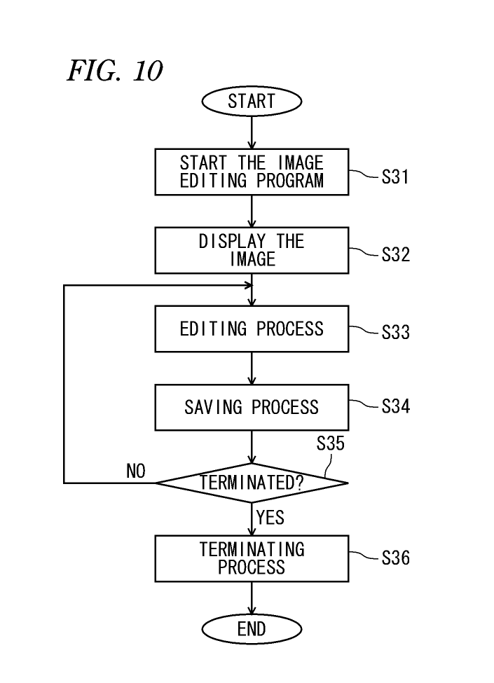

In other words, copying file data to a predetermined storage area 31a of the NAS 31 is performed by copying the file data to a predetermined folder that was generated in the NAS 31, and the PC 2A reads the file data of the still image that was copied to the predetermined folder. FIG. 10 is a flowchart showing an exemplary processing flow of an editing process in the PC 2. Processing shown in FIG. 1 is executed by the controller 11 of the PC 2.

First, when a user instructs to execute an image editing program, the controller 11 starts the image editing program 2a (S31).

Next, as an editing object image can be selected by using the function of the image editing program 12a, the controller 11 executes an image display process for displaying an editing object image on the display unit 13 as a monitor of the PC 2 (S32).

In a predetermined folder of the NAS 31, there is a file data stored for the image selected at the TV 3. Thus, in step S32, a user can select the image being displayed on the TV 3 as an image to be edited from a predetermined folder, and display it on the display unit 13.

By using the image editing program 12a, a user can display a selected image on the display unit 13 of the PC 2, and perform various editing.

When a user enters an image data saving command after an image editing process, the controller 11 executes a saving process for saving an edited image file in the NAS 31 (S34). At this time, as the image data under editing has been deployed on the RAM, the image data is encoded, sent to, and saved in the NAS 31, those which can be performed by the functions of the image editing program 12a. The saving process may be executed not only by entry of the saving command, but also by execution of the image editing process. In other words, when the data saving command is entered or when the image editing process is executed, the PC 2A as an image editing unit stores file data of the edited image in the NAS 31 as a storage unit.

The controller 11 determines whether an instruction to terminate execution of the image editing program 12a is entered (S35). When the termination instruction is not entered (S35: NO), the processing returns to step S33. When the termination instruction is entered (S35: YES), the controller 11 executes a termination process for terminating execution of the image editing program 12a (S36).

When the termination instruction is not entered (S35: NO), the processing returns to step S33, and a user can perform further image editing.

Next, returning to FIG. 9, after step S24, the controller 21 monitors file data stored in a predetermined folder of the NAS 31 at predetermined intervals, for example, at 100-msec intervals, and determines whether the file data is changed (S25).

The determination can be made by comparing the updated date of the file read last time with the updated date of the file read this time. In other words, whether image editing is performed is determined based on an updated date of file data of a still image stored in the NAS 31.

When the file data has been changed (S25: YES), the controller 21 reads again file data of the image stored in a predetermined folder (S26), and decodes the read file data by the decoder 22, and displays the decoded image (S27). Then, the controller 21 generates and displays a message such as “Data has been read again.” and “Display has been updated.” (S28). By such a message, a user can recognize that the edited image is being displayed on the TV 3A. Thereafter, the processing returns to step S25.

When the file data has not been changed (S25: NO), nothing is done.

In the above example, only when file data is changed in step S25, file data of the image is read again (S26), and the image is displayed (S27). Alternatively, it is possible to use a timer function and configure it such that at every timing of a fixed time elapses (namely, at certain time intervals), the controller 21 may read again file data of an image regardless of whether a file data change is changed or not, and display an image.

Further, the controller 21 may read again file data of an image and display an image according to a predetermined instruction to the operation device, such as a remote controller, as one of the input unit 25 of the TV 3A. Namely, it is also possible to employ another configuration such that just in case of a predetermined instruction being entered from a remote controller or the like, the controller 21 may read again file data of an image, and display an image.

Further, in the above example, although a single image file is usually copied to a predetermined folder generated in step S22, it is also likely to happen that another image data file may be additionally copied to a predetermined folder after the predetermined folder is generated. In such a case, it can be configured such that when a user selects an image to be edited out of multiple images in the predetermined folder, a predetermined character, symbol or, date and time may be added to a file name to discriminate the image being currently selected as an image to be edited from other images. By discriminating such a selected file by a file name according to the file name, the PC 2 can display the image, which was displayed by the user on the TV 3A in the photo play mode, on the display unit 13.

For example, when a user selects an image stored in a file among plural files, a file name of the selected image may be changed by adding copy data-and-time numbers to its original file name so as to distinguish the file of the selected image from the remain plural files. When the user does not select or selects another image stored in another file, the file name of the previously selected image may be returned to its original file name.

Otherwise, flag data indicating a file being selected may be added to a file name to discriminate it from other files.

Thus, the PC 2 can discriminate an image being selected as an image to be edited.

Further, when a rereading process is executed, images before and after editing may be displayed side by side to enable a user to compare the images before and after editing.

As described above, the TV 3A as a display unit copies file data of image data of a captured still image to a predetermined storage area of the NAS 31, reads and decodes the file data of image data of the still image stored in the NAS 31, and displays the still image on a screen of the TV 3A. The PC 2 as an image editing unit for performing image editing reads file data of the still image data from the NAS 31, and performs image editing edits by the image editing program 12a, and after the image editing, stores file data of the edited image data in the NAS 31. After the image editing, the TV 3A reads again and decodes the file data of the edited image data stored in the NAS 31, and displays the image on the screen.

Therefore, according to the embodiment, it is possible to provide an image display method capable of performing image editing by displaying an editing object image on the TV 3A as a display unit separate from the PC 2A as an image editing unit, easily without deteriorating image quality, while displaying an image being edited substantially in real time.

As described above, according to an image display system of each embodiment, it is possible to realize an image display method that enables a user to easily edit an image while checking an editing result by viewing a high-definition image displayed on a TV screen, by cooperating a PC as an editing unit with a television as a display unit.

Further, when such an image display system is realized, it is possible to display a photograph of a still image aimed by a photographer on a display unit. Therefore, it is possible to open a photo exhibition using a display unit such as a 4K or 8K high-resolution television.

Conventionally, a photographer needs to print an image edited on a PC by a printer, check a printed photo, and edit an image. On the other hand, in an exhibition using a display unit such as a high-resolution television, editing is possible while checking a final output state of a photograph. This eliminates the necessity of re-editing by viewing a photograph printed by a conventional printer.

Although file data of an image is JPEG format data in two embodiments describe above, file data may be other format data, and in this case, a decoder is configured to decode according to a format of file data.

Although embodiments of the invention haven been explained hereinbefore, it is to be noted that these embodiments are shown as an example and not to limit the scope of the invention. The invention may be embodied in other specific forms, and may be omitted, replaced or modified without departing from its spirit and essential characteristics. All embodiments and modifications are to be included in the scope and essential characteristics of the invention, and come within the scope of the invention and its equivalency defined by the appended claims.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image display method, comprising:
editing image data of a captured still image by an image editing unit using an image editing program;
transmitting file data of the edited image data from the image editing unit to a display unit;
receiving the file data of the edited image data by the display unit;
decoding the received file data of the edited image data by a decoder; and
displaying a still image which is generated by decoding the received file data on a screen of the display unit.

2. The image display method of claim 1, further comprising:
monitoring an execution state of the image editing program to detect whether the image editing is performed.

3. The image display method of claim 1,
wherein the transmission of the file data of the edited image is performed by a plug-in program added to the image editing program.

4. The image display method of claim 1,
wherein the display unit includes a first play mode, and
when the display unit is in the first play mode:
the file data of the edited image is received; the file data of the edited image is decoded; and a still image generated by decoding is displayed.

5. The image display method of claim 1,
wherein the display unit is a television receiver connected to the image editing unit via a wired or wireless network.

6. An image display method, comprising:
copying file data of image data of a captured still image to a first storage area of a storage unit by a display unit;
reading the file data stored in the storage unit by display unit;
decoding the read file data by the display unit;
displaying the still image of the decoded file data on a screen of the display unit;
reading the file data from the storage unit by an image editing unit which performs image editing;
editing the read file data by the image editing unit using an image editing program;
storing the edited file data in the storage unit by the image editing unit;
rereading the file data stored in the storage unit by the display unit after the image editing;
decoding the reread file data by the display unit; and
displaying the still image of the decoded file data on a screen by the display unit.

7. The image display method of claim 6,
wherein the image editing unit stores the edited file data in the storage unit after a data save command is entered or the image editing is executed.

8. The image display method of claim 6,
wherein the display unit determines whether the image editing is performed, based on an updated date-and-time of the file data of image data of the still image stored in the storage unit.

9. The image display method of claim 6,
wherein the copying is performed by copying the file data to a first folder generated in the storage unit, and
the image editing unit reads the copied file data in the first folder.

10. The image display method of claim 9,
wherein when a first mode is set, the display unit generates the first folder in the storage unit.

11. The image display method of claim 6,
wherein the storage unit is connected to the display unit via a wired or wireless network.

12. The image display method of claim 6,
wherein the display unit is a television receiver.
